(19) United States
(12) Patent Application Publication
(10) Pub. No.: US 2010/0078973 A1
(43) Pub. Date: Apr. 1, 2010

(54) Dual-chair beach wagon

(76) Inventor: Robert L. Tyson, III, Raleigh, NC (US)

Correspondence Address: LITMAN LAW OFFICES, LTD., POST OFFICE BOX 41200, SOUTH STATION, ARLINGTON, VA, 22204, US

(21) Appl. No.: 12/585,768

(22) Filed: Sep. 24, 2009

Related U.S. Application Data
(60) Provisional application No. 61/136,739, filed on Sep. 29, 2008.

(51) Int. Cl. A47C 13/00; B62B 3/02

(52) U.S. Cl. 297/129; 280/30

(57) ABSTRACT

The dual-chair beach wagon is a rolling cart that can be converted into separately usable beach chairs after a user has finished transporting items with the beach wagon. The cart comprises opposing beach chairs designed with wheels. Beach chairs are removably connected together at opposing ends to form a wagon. When disconnected each chair serves as a standard beach chair. The beach chairs include reconfigurable legs equipped with retractable wheels. In preparation for beach wagon mode, the front legs can be folded up into a recessed locked position to facilitate attachment of the two chairs to form the beach wagon. A rotatable platform joins the axle of one of the chairs to facilitate wagon transport.

### CROSS-REFERENCE TO RELATED APPLICATION

This application claims the benefit of U.S. Provisional Patent Application Ser. No. 61/136,739, filed Sep. 29, 2008.

### BACKGROUND OF THE INVENTION

1. Field of the Invention

The present invention relates generally to portable seating, and more specifically to a dual-chair beach wagon that combines beach chairs to create a beach wagon.

2. Description of the Related Art

A beach wagon is very desirable for beach goers (families) who take lots of items from their car/house to the beach when packing for a day at the beach. Many families take large children's wagons loaded down with beach chairs, beach umbrella, towels, coolers, and beach toys etc. when packing for a day at the beach. The Dual Chair Beach Wagon concept consolidates the beach chairs and beach wagon into one multi purpose item that can reduce some of the many separate items families haul down to the shore.

Also, it would be desirable to have an item that reduces a beach wagon storage area needed in a family's vehicle. So many families have to deal with negotiating space to pack a wagon when packing it on a trip to the beach for the convenience of carrying all their beach items to the shore. The concept of a dual chair beach wagon reduces the storage of a beach wagon down to the storage area of two folded beach chairs.

Thus, a dual-chair beach wagon solving the aforementioned problems is desired.

### SUMMARY OF THE INVENTION

The dual-chair beach wagon is a rolling cart that can be converted into separately usable beach chairs after a user has finished transporting items with the beach wagon. The cart comprises opposing beach chairs designed with wheels. Beach chairs are removably connected together at opposing ends to form a wagon. When disconnected each chair serves as a standard beach chair. The beach chairs include reconfigurable legs equipped with retractable wheels. In preparation for beach wagon mode, the front legs can be folded up into a recessed locked position to facilitate attachment of the two chairs to form the beach wagon. A rotatable platform joins the axle of one of the chairs to facilitate wagon transport.

These and other features of the present invention will become readily apparent upon further review of the following specification and drawings.

### BRIEF DESCRIPTION OF THE DRAWINGS

FIG. 1 is an environmental, perspective view of a dual-chair beach wagon according to the present invention.

FIG. 2 is a partially exploded, perspective view of the dual-chair beach wagon according to the present invention.

Similar reference characters denote corresponding features consistently throughout the attached drawings.

### DETAILED DESCRIPTION OF THE PREFERRED EMBODIMENTS

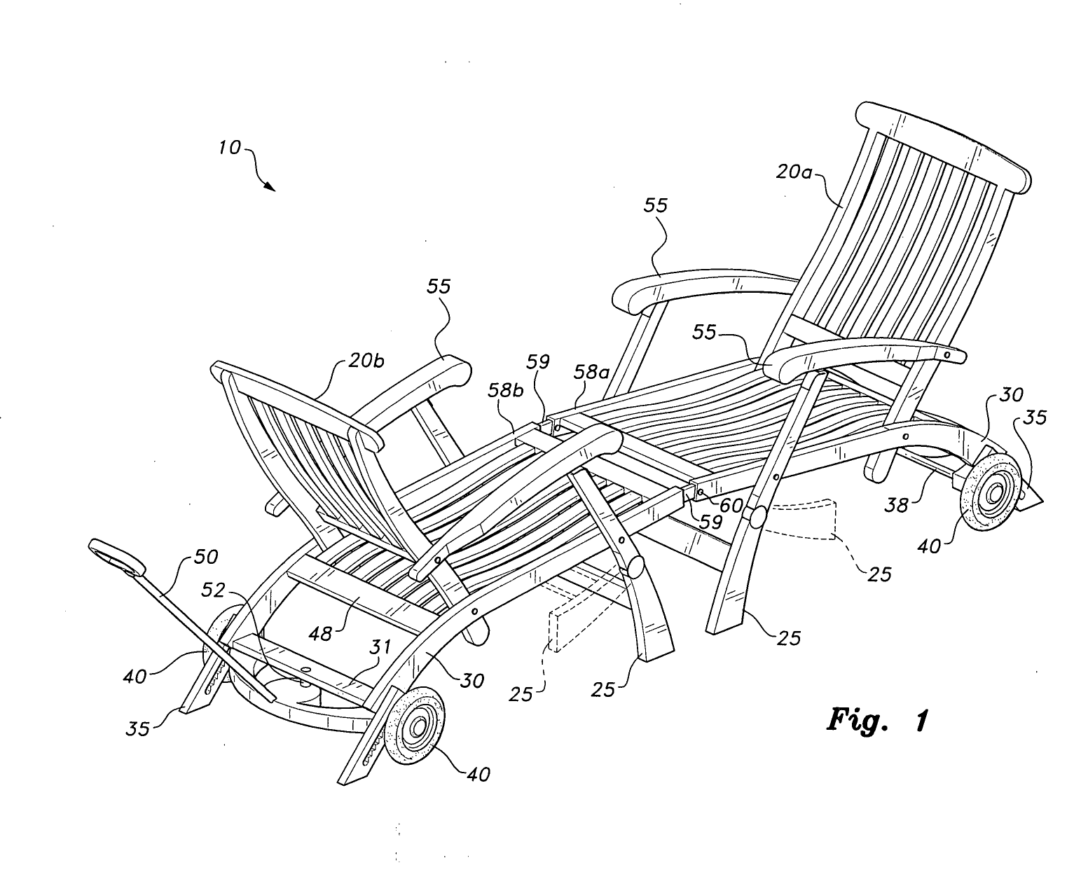

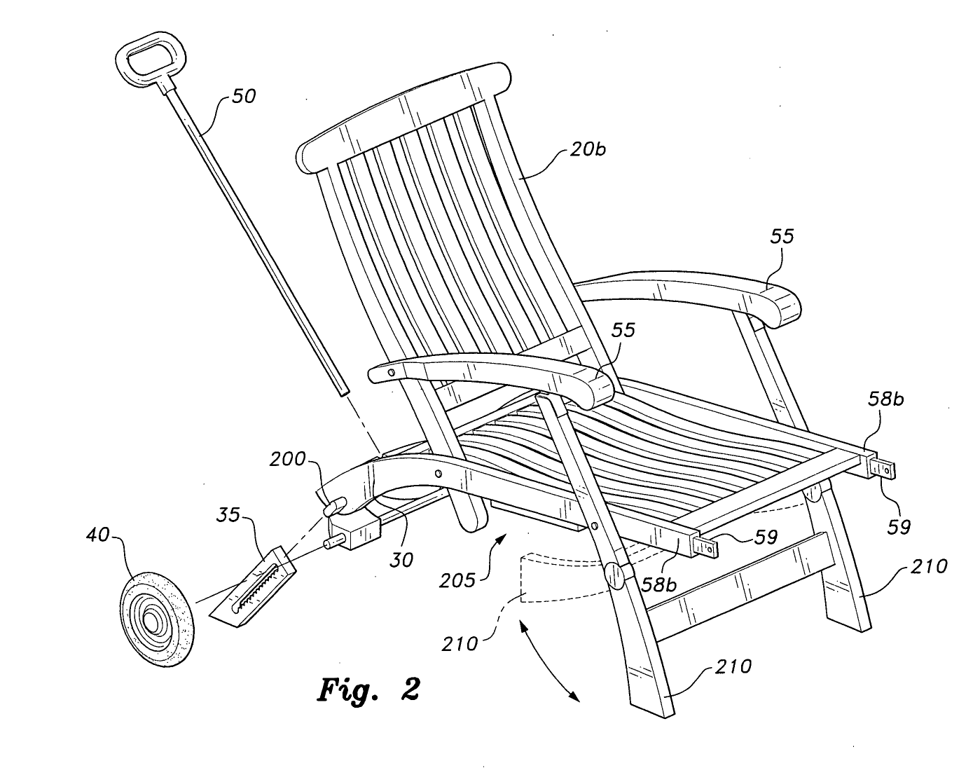

As shown in FIGS. 1 and 2, the dual-chair beach wagon 10 is a device that can be broken down into two beach chairs 20a and 20b. The beach wagon 10 comprises opposing beach chairs 20a and 20b and sets of wheels 40 connected to axles 38. Lower frame members 30 form the periphery of seat portion of chairs 20a and 20b. An extension member 59 extends from front portion 58b of beach chair 20b. The extension member 59 may be equipped with a recess or through bore proximate its end. Front portion 58a of beach chair 20a is hollow and adapted to receive extension member 59. Two pins 60 inserted through holes in respective front portions 58a of beach chair 20a align with the hole or recess in extension member 59 to securely connect the two chairs 20b and 20a together thus forming the wagon 10. In versions of the chairs where arms 55 are long, the connection may be fortified by attaching the arms 55 as well as front seat portions 58a and 58b. When disconnected, chair 20a and chair 20b serve as standard individual beach chairs.

Each of beach chairs 20a and 20b includes attachment boss 200 for attachment of reconfigurable legs 35 equipped with retractable wheels 40 attached to axles 38. The wheel 40 can be ratcheted up or down via ratchet mechanism disposed in reconfigurable wheeled legs 35. The front legs 25 include a pivotal locking mechanism allowing the legs 25 to be folded away into a recess on the chair when a user desires the beach wagon configuration. Note that front portion of the legs 25 has an arcuate design 210. Legs 25 may be fixed or adjustable. Additionally chair 20b has a storage bin 205 disposed under a lower portion of the chair. Hardware or material may be strategically attached on either chair 20a or 20b allowing for storage compartments that may be suspended from the exterior body of the wagon as when the chairs 20a and 20b have been assembled.

When the user desires a standard chair configuration, the chair legs 25 may be pulled out from the recessed portion of chairs 20a and 20b and assembled to form a sturdy forward chair leg assembly.

A steering platform 52 is attached to the wheel assembly, which includes axle 38, the steering platform being pivotally attached to lower cross member 31 of chair 20b. A steering handle 50 is attached to front arcuate portion of the steering platform 52. Upper cross member 48 reinforces the rear portion of chair 20b.

It is to be understood that the present invention is not limited to the embodiment described above, but encompasses any and all embodiments within the scope of the following claims.

I claim:

1. A dual-chair beach wagon, comprising:
first and second beach chairs;
first and second wheel and axle assemblies adjustably attached respectively to the first and the second beach chairs;
a first wheel and axle assembly rotatable with respect to the first beach chair, the first wheel and axle assembly steering the dual-chair beach wagon;
a steering handle attached to the first wheel and axle assembly, the steering handle guiding the steering of the rotatable first wheel and axle assembly;
adjustable front legs on each of the first and the second beach chairs; and
at least one attachment member removably attaching a front portion of the first beach chair to a front portion of the second beach chair.

2. The dual-chair beach wagon according to claim 1, wherein the first and second beach chairs each have lower frame members forming the periphery of seat portions of the chairs.

3. The dual-chair beach wagon according to claim 1, wherein the at least one attachment member removably attaching front portions of the beach chairs is an extension member having a recess, the front portion of at least one of the chairs being hollow and receiving the extension member.

4. The dual-chair beach wagon according to claim 3, further comprising two pins insertable through holes in respective front portions of said second beach chair, the pins aligning with the recess in said extension member, thereby securely connecting said two chairs together to form a wagon.

5. The dual-chair beach wagon according to claim 1, wherein said first and second beach chairs each further comprise chair arms, the chair arms of said first beach chair being removably attachable to the chair arms of said second beach chair.

6. The dual-chair beach wagon according to claim 1, wherein the adjustably attached axle assemblies comprise leg extensions having a ratcheting mechanism adjusting the height of the wheels.

7. The dual-chair beach wagon according to claim 1, wherein the adjustable front legs are pivotal up into a retracted position and down into a locked, extended position.

8. The dual-chair beach wagon according to claim 1, further comprising an upper cross member disposed laterally across the first beach chair, reinforcing a rear portion of said first beach chair proximate said first wheel and axle assembly.

9. The dual-chair beach wagon according to claim 1, wherein at least one of said chairs includes at least one storage container disposed on a portion thereof.
